(19) United States
(12) Patent Application Publication
(10) Pub. No.: US 2013/0166317 A1
(43) Pub. Date: Jun. 27, 2013

(54) SYSTEM AND METHOD FOR VISUALIZING PATIENT TREATMENT MEASURES IN A NETWORK ENVIRONMENT

(71) Applicant: NET.ORANGE, INC., Dallas, TX (US)

(72) Inventors: Robert W. Beardall, Cheshire (GB); Gregory J. Poe, Dallas, TX (US); Vasu Rangadass, Arlington, TX (US); Ravi Seshadri, Plano, TX (US)

(73) Assignee: NET.ORANGE, INC., Dallas, TX (US)

(21) Appl. No.: 13/773,503

(22) Filed: Feb. 21, 2013

Related U.S. Application Data
(63) Continuation-in-part of application No. 12/536,060, filed on Aug. 5, 2009.
Application No. 12/536,060 is a continuation-in-part of application No. 12/816,804, filed on Jun. 16, 2010.
Application No. 12/816,804 is a continuation-in-part of application No. 12/536,060, filed on Aug. 5, 2009.
(60) Provisional application No. 61/086,344, filed on Aug. 5, 2008.
(60) Provisional application No. 61/086,344, filed on Aug. 5, 2008.

(51) Int. Cl. G06F 19/00; G06Q 50/22

(52) U.S. Cl. CPC G06F 19/324; G06Q 50/22
USPC 705/2

(57) ABSTRACT

A method for visualizing patient treatment measures in a network environment is provided in one example embodiment and includes receiving a request from a client for data in a network environment, where the data includes services data and a clinical pathway, generating data rendering instructions for rendering the data as a visual display at the client, the data rendering instructions including options to configure the visual display. The visual display includes a graphical representation of analysis of the services data in view of the clinical pathway, and visual aids that reveal information upon user selection. The method further includes delivering the data rendering instructions to the client and facilitating access to the data by the client.

### CROSS-REFERENCE TO RELATED APPLICATION

This Application is a continuation-in-part and claims the benefit of priority under 35 U.S.C. §120 to U.S. application Ser. No. 12/536,060, entitled “Operating System” filed Aug. 5, 2009, which application claims the benefit of priority to U.S. Provisional Application Ser. No. 61/086,344, entitled “Operating System” filed Aug. 5, 2008. This Application is also a continuation-in-part and claims the benefit of priority under 35 U.S. §120 to U.S. application Ser. No. 12/816,804, entitled “Operating System” filed Jun. 16, 2010, which application is a continuation-in-part of U.S. patent application Ser. No. 12/536,060, entitled “Operating System” filed Aug. 5, 2009, which application in turn claims the benefit of priority to U.S. Provisional Patent Application Ser. No. 61/086,344, entitled “Operating System” filed Aug. 5, 2008. The disclosures of the prior applications are considered part of, and are incorporated by reference in their entireties in, the disclosure of this Application.

### TECHNICAL FIELD

This disclosure relates in general to the field of healthcare systems and, more particularly, to a system and a method for visualizing patient treatment measures in a network environment.

### BACKGROUND

Paper-based medical records have been in existence for centuries and are being gradually replaced by computer-based records in modern healthcare systems. Hospitals are increasingly using electronic medical records (EMRs), electronic health records (EHRs), electronic patient records (EPRs), computer-based patient records (CPRs), etc. to capture and manage patients' medical and health information electronically. As of 2002, there were five different types of personal health records: (i) off-line personal health record; (ii) web-based commercial personal health record; (iii) web-based functional personal health record; (iv) provider based personal health record; and (v) web-based partial personal health record. Except for the provider based personal health record, all the other types of personal health records were created by the patient or by third parties, not including the health provider. The types and formats of health records have increased exponentially since 2002, and there currently exists myriad, diverse electronic representations of health and medical records from a wide variety of medical systems and other sources.

### BRIEF DESCRIPTION OF THE DRAWINGS

To provide a more complete understanding of the present disclosure and features and advantages thereof, reference is made to the following description, taken in conjunction with the accompanying figures, wherein like reference numerals represent like parts, in which:

FIG. 1 is a simplified block diagram illustrating a healthcare monitoring system for visualizing patient treatment measures in a network environment according to an example embodiment;

FIG. 2 is a simplified diagram illustrating example details of an embodiment of the healthcare monitoring system;

FIG. 3 is a simplified block diagram illustrating yet other example details of an embodiment of the healthcare monitoring system;

FIG. 4 is a simplified diagram illustrating example details that may be associated with an embodiment of the healthcare monitoring system;

FIG. 5 is a simplified flow diagram illustrating example operations that may be associated with an embodiment of the healthcare monitoring system;

FIG. 6 is a simplified flow diagram illustrating other example operations that may be associated with an embodiment of the healthcare monitoring system;

FIG. 7 is a simplified flow diagram illustrating yet other example operations that may be associated with an embodiment of the healthcare monitoring system; and

FIG. 8 is a simplified flow diagram illustrating yet other example operations that may be associated with an embodiment of the healthcare monitoring system.

### DETAILED DESCRIPTION OF EXAMPLE EMBODIMENTS

### Overview

A method for visualizing patient treatment measures in a network environment is provided in one example embodiment and includes receiving a request from a client for data in a network environment, where the data includes services data and a clinical pathway, generating data rendering instructions for rendering the data as a visual display at the client, the data rendering instructions including options to configure the visual display. The visual display includes a graphical representation of analysis of the services data in view of the clinical pathway, and visual aids that reveal information upon user selection. The method further includes delivering the data rendering instructions to the client and facilitating access to the data by the client.

In some embodiments, the data can include medical data and the visual display can include a second graphical representation of the medical data overlaid on the graphical representation of analysis of the services data in view of the clinical pathway. In a specific embodiment, the second graphical representation is a spark line depiction. The medical data can include an overlay parameter selectable by a user viewing the visual display.

In specific embodiments, the visual display is configurable to display the services data according to a length of service specified in the clinical pathway. The graphical representation can include one or more data points corresponding to treatment measures, where at least one data point is selectable to reveal details about the data point. The graphical representation can also include status of the treatment measures. For example, the status can include “delivered,” “not delivered within time specification,” “not delivered but can still gain credit,” “not delivered with contradiction documented,” “future activity,” and “viewer responsible.” In specific embodiments, the status is determined by comparing the treatment measures with the clinical pathway. In some embodiments, the visual display is rendered on a browser at the client.

### Example Embodiments

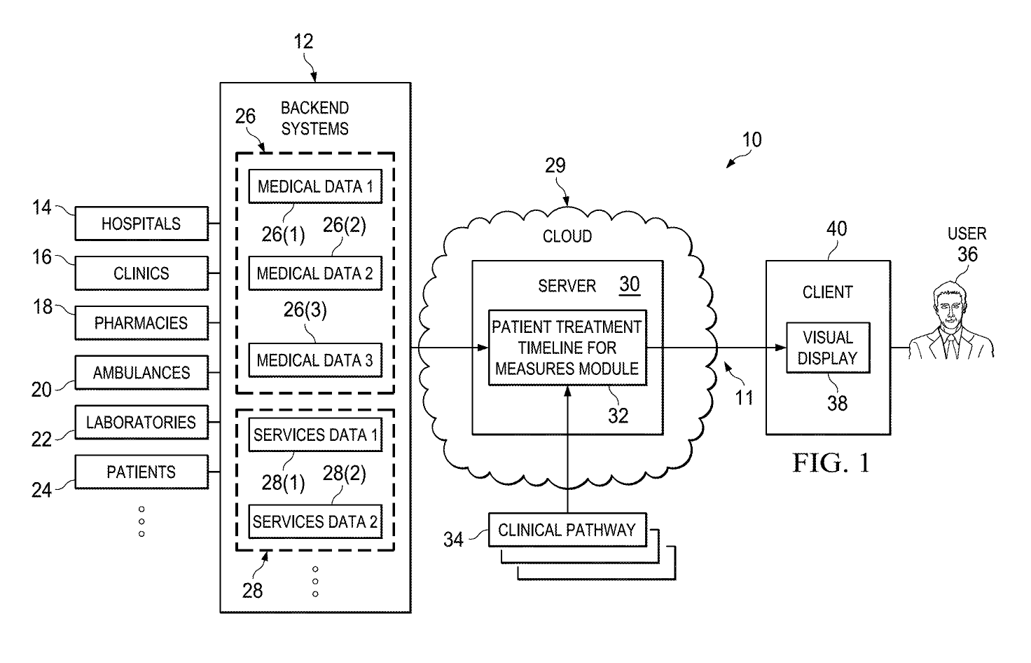

Turning to FIG. 1, FIG. 1 is a simplified block diagram illustrating a healthcare monitoring system 10 for visualizing patient treatment measures in a network environment. Healthcare monitoring system 10 includes a network 11 (generally indicated by an arrow) comprising backend systems 12 that may be associated with myriad data sources, including hospitals 14, clinics 16, pharmacies 18, ambulances 20, laboratories 22, patients 24, etc. The examples of medical data sources provided herein are merely for ease of illustration, and are not intended to be limitations. Virtually any type and number of medical data sources may be encompassed in the broad scope of the embodiments.

The various medical data sources may generate or provide medical data 26, for example, medical data 26(1)-26(3) comprising various pieces of information in various formats. As used herein, the term “medical data” includes information (e.g., facts) related to diagnosis and treatment of a current or potential health condition (e.g., disease, diabetes, obesity, aging, etc.). Medical data 26 includes health information of an individual (e.g., information pertaining to the health of the individual or health care provided to the individual) collected from the individual at one or more of medical data sources, including hospitals 14, nursing homes, medical centers, clinic 16, health or nursing agencies, health care facilities, or medical data provided by the patients 24, or relatives and friends of the patient.

Medical data 26 can include demographic information (e.g., age, weight, gender) that may be relevant to diagnosis and treatment of a current or potential health condition. Medical data 26 may be generated during encounters (e.g., visit at physician's office, laboratory testing, in-home testing). In a general sense, data, including medical data 26, refers to any type of numeric, text, voice, video, or script data, or any type of source or object code, or any other suitable information in any appropriate format that may be communicated from one point to another in electronic devices and/or networks.

The various medical data sources may also generate or provide services data 28, for example, services data 28(1)-28(2). “Services data” as used herein includes information pertaining to health care services. Services data can include primary health care services (e.g., care and services provided by a physician and nurse under the direct guidance of a physician) and ancillary services (e.g., supplies and laboratory tests provided under home care, audiology, durable medical equipment (DME), ambulatory surgical centers (ASC), home infusion, hospice care, skilled nursing facility (SNF), cardiac testing, mobile lithotripsy, fitness center, radiology, pulmonary testing, sleep centers, and kidney dialysis). Health care services that generate services data 28 can include diagnostic (e.g., diagnosis of health conditions and diseases), therapeutic (e.g., treatment of health condition and diseases) and custodial (e.g., care provided by a nursing home or hospital) health care services.

Backend systems 12 may communicate medical data 26 and services data 28 to a cloud 29 comprising a server 30 provisioned with a patient treatment timeline for measures module 32. One or more clinical pathway 34 may be provided to treatment timeline for measures module 32. “Clinical pathway” as used herein includes a treatment care plan, comprising one or more treatment measures specified to be delivered to the patient according to a predetermined schedule. As used herein, the term “treatment measure” includes clinical and other related measures (e.g., events, activities, procedures, actions) provided to (or performed on) a patient. For example, treatment measures for an antepartum clinical pathway can include: review of history for factors that can affect pregnancy outcome; review of medication and allergy; review of past complications that could repeat in future pregnancies; review of lifestyle issues that can affect pregnancy outcome; pelvic examination; pap smear, etc. Treatment measures for a diabetic inpatient footcare clinical pathway can include inspecting feet within 4 hours of admission; determining if skin discoloration exists; diagnosing whether ulcer, foot sepsis, etc., exists; recommending surgical review; etc.

In some embodiments, each individual patient may be associated with a unique clinical pathway, identified by the patient's identifier (e.g., social security number, first and last name, or other suitable identifier). In other embodiments, a typical clinical pathway may be associated with substantially all patients (in the hospital or health care setting) having the health condition relevant to the clinical pathway. The clinical pathway can include a statement of the individual's assessed health care services needs setting out what services s/he should get, why, when, and details of who can provide it (or is responsible for providing it). Clinical pathway 34 can include nursing orders (e.g., setting out guidance to nursing care) for a specific patient, general (e.g., standardized) treatment plans for a specific disease individualized to the specific patient, and other health care treatment related to the specific patient. Clinical pathway 34 can specify a recommended care process, sequencing and timing of interventions by healthcare professionals for a particular diagnosis or procedure. According to various embodiments, patient treatment timeline for measures module 32 may enable a user 36 to view the impact of treatment measures according to clinical pathway 34 on a suitable visual display 38 at client 40.

For purposes of illustrating the techniques of healthcare monitoring system 10, it is important to understand the communications in a given system such as the system shown in FIG. 1. The following foundational information may be viewed as a basis from which the present disclosure may be properly explained. Such information is offered earnestly for purposes of explanation only and, accordingly, should not be construed in any way to limit the broad scope of the present disclosure and its potential applications.

The development of an Information Technology (IT) infrastructure in healthcare delivery has enormous potential to improve the safety, quality, and efficiency of health care and health delivery. Computer-assisted diagnosis can improve clinical decision making. Computer-based reminder systems can improve compliance with preventive service protocols. Immediate access to computer-based clinical information, such as laboratory and radiology results can improve quality of healthcare delivery. Likewise, the availability of complete patient health information at the point of care delivery, clinical decision support systems and other computer-assisted healthcare monitoring systems can prevent many errors and adverse events. Patient health information can be shared among all authorized participants in the health care community via secure IT infrastructure

In healthcare settings, the absence of a formal care planning system can leads to errors of omission. Consequently, crucial steps in the care process can be forgotten or not followed through appropriately. Further, a team approach is often lacking, resulting in poor discharge planning and inadequate patient education. Clinical pathways to alleviate such problems are typically developed through collaborative efforts of clinicians, case managers, nurses, and other healthcare professionals. Clinical pathways can reduce unnecessary variation in patient care, reduce delays, and improve the cost-effectiveness of medical services. Clinical pathways may be considered a form of multidisciplinary management plans that display goals for patients and provide the corresponding appropriate sequence and timing of staff interventions to achieve those goals with optimal efficiency.

One of the typical goals of implementing clinical pathways includes examining the interrelationships among the different steps and stages in the care process and to engineer strategies to coordinate or decrease the time spent in the rate limiting steps. It can also aim to provide a framework for collecting and analyzing data on the care process so that providers can understand how often and why patients do not follow an expected course during their hospitalization. In some cases, the clinical pathway can be a plan of care that reflects best clinical practice and the expressed needs of a typical patient on the pathway. Such a clinical pathway represents the minimum standard of care and ensures that the essentials are not forgotten and are performed on time. Clinical pathways are typically written in the form of a grid (or matrix) which displays aspects of care on one axis and time intervals on another. The time intervals are typically in the form of a day by day clinical order and documentation sheet with variations depending on the nature and progression of illness or procedure being performed. For example, clinical pathways designed for chronic conditions could have timelines in the form of weeks or months.

Clinical pathways are often used to collect and analyze information for determining when patients deviate from the clinical pathway. Analysis of variation can provide useful and accurate information on the frequency and causes of variations in patient care. For example, the analysis can encourage members of the healthcare team to adhere to the guidelines (specified in the clinical pathway) more strictly in the future. Thus, clinical pathways can compel healthcare providers to critically evaluate and understand the basis of clinical decisions.

Analysis of variance can be a powerful clinical audit tool to review and revise aspects of patient care at a hospital or other healthcare facility. The recording, collection and analysis of variances provide continuous audit data on the care being delivered. Such audit information may be specific to each case on the clinical pathway being analyzed. Analysis can highlight deficiencies in the care process due to problems arising from the hospital system. Clinical pathways can also facilitate outcome audit analysis as relevant documents can be identified and studied to ascertain whether or not the interventions resulted in the desired clinical outcomes as stated on the clinical pathway.

However, variance analysis is often complicated by the sheer volume and magnitude of data. Further, there is a lack of statistical independence among specific variances (e.g., many activities prescribed on the pathway can be related to one another). Moreover, a variance that occurs early in the pathway may affect the timing of subsequent activities, causing a “cascade” effect through the rest of the care delivery process, resulting in variances in other activities later in the pathway.

Paper based systems for variance collection are used in many hospitals, though they are being replaced by computer systems. Computers remove the problems (errors, lack of organization, etc.) inherent in manual data collection and analysis. An example computerized clinical pathway variance and management system implemented in some hospital systems has the ability to adapt the clinical pathway to changes in the patient's condition that are normally seen as variances.

Computers clinical pathways analysis may be performed inside a larger Clinical Decision Support System (CDSS). CDSSs are typically designed to integrate a medical knowledge base, patient data and an inference engine to generate case specific advice. Characteristics of individual patients may be used to generate patient-specific assessments or recommendations that are then presented to clinicians for consideration. Four functions of electronic clinical decision support systems include: Administrative functions (e.g., supporting clinical coding and documentation, authorization of procedures, and referrals); management functions (e.g., keeping patients on research and chemotherapy protocols, tracking orders, referrals follow-up, and preventive care); cost control functions (e.g., monitoring medication orders, avoiding duplicate or unnecessary tests); and decision support functions (e.g., supporting clinical diagnosis and treatment plan processes, and promoting use of best practices, condition-specific guidelines, and population-based management).

Examples of CDSSs include manual or computer based systems that attach care reminders to the charts of patients needing specific preventive care services and computerized physician order entry systems that provide patient-specific recommendations as part of the order entry process. Such systems generally improve prescribing practices, reduce serious medication errors, enhance the delivery of preventive care services, and improve adherence to recommended care standards, for example, as specified in appropriate clinical pathways.

ATHENA-DSS is an automated decision support system developed by Stanford University and the U.S. Department of Veterans Affairs (VA) to increase guideline-adherent prescribing and to change physician behavior. Based on data in patients' computerized medical record and knowledge of the clinical domain encoded in a knowledge base, the ATHENA-DSS system gives patient-specific recommendations to primary care providers at the point of care. The graphical user interface (GUI) of the ATHENA-DSS shows two identifiers: name and social security number, to help ensure information on the correct patient is presented. Important patient characteristics relevant to specific prescriptions are highlighted in red with a pink background to draw the provider's attention to the area. Patient-specific recommendations for treatment provide information and recommendations relevant to patient characteristics highlighted in the cautions table, as well as detailed instructions for possible general treatment options the provider may be considering. Potentially relevant information on history of prescriptions, allergies, diagnoses, labs, and vital signs are presented in tabular form.

In the ATHENA-DSS, recommended chronic pain care practices that should be carried out at all visits are listed for the provider to check when completed. Drop down menus include tools to assist the primary care physician with chronic pain management. Tools include a structured pain assessment, instructions for conducting urine drug screens and making patient referrals to specialty care, a conversion calculator, patient education materials, and information about useful community resources. However, ATHENA-DSS does not provide a graphical picture of a comparison between the clinical pathway and treatment measures for the patient over the course of the treatment.

Moreover, a user (e.g., healthcare professional or patient) viewing the textual CDSS information in ATHENA-DSS and similar systems may fail to understand key aspects of the numeric and other information that is presented simply as text. Graphical displays in such context can permit the users to quickly comprehend response patterns to therapy and treatments. Graphs can present medical data in a visually interesting format, and exploit rapid, automatic visual perception skills. A well designed visual display can reduce the amount of mental computation by replacing it with automatic visual perception.

Graphs can reveal data patterns that may go undetected otherwise. For example, line graphs can efficiently convey trends in data, pie charts and divided bar graphs can depict proportions, etc. Specific graph types may evoke automatically specific mathematical operations. For example, given a particular task (e.g., comparing risks), certain graphs allow the observer to process the information more effectively than when numbers are presented alone. Moreover, unlike numbers, graphs can attract and hold people's attention because they display information in concrete, visual terms. However, if the graphs are not well designed, some aspects of graph interpretation can require more effortful cognitive skills such as interpretation and calculation, prone to misinterpretation and leading to erroneous decisions.

A challenge in presenting a proper visual display that can give sufficient information to appropriate users (e.g., physicians, patients, etc.) is to provide the information in a visually appealing manner while simultaneously maximizing the amount of information presented. Many existing electronic health record (EHR) systems and CDSSs provide a peep-hole view of the individual's health history, for example, presenting only a portion of the data to physicians. Reasons for such partial display of health history can range from lack of access to relevant data, to lack of computing resources and mechanisms to display the data efficiently.

Healthcare monitoring system 10 is configured to address these issues (and others) in offering a system and a method for visualizing patient treatment measures in a network environment. Embodiments of healthcare monitoring system 10 can provide a suitable visual display 38 of the impact of treatment measures according to clinical pathway 34. In various embodiments, client 40 may request medical data 26 from cloud 29, for example, through a secure HTTP request. Patient treatment timeline for measures module 32 may respond with data rendering instructions to client 40. The data rendering instructions may allow client 40 to access medical data 26, services data 28 and clinical pathways 34 and display them suitably in a comprehensive visual display 38.

In many embodiments, online analytical process (OLAP) may be embedded in healthcare monitoring system 10 to facilitate the operations described herein. Some embodiments may implement asynchronous JavaScript XML-HTTP-Request (AJAX) model to retrieve instant information and avoid lag in transportation of client-server data. For example, transient data may be stored at client 40, thereby reducing redundant data query with server 30 in cloud 29. Heavyweight database queries may be implemented at server 30, and lightweight data analysis may be performed at client 40. With AJAX, browsers at client 40 can send data to, and retrieve data from, server 30 asynchronously (e.g., in the background) without interfering with visual display 38. For example, data can be retrieved using an XMLHttpRequest object.

Medical data 26 provided by backend systems 12 may be appropriately tagged or otherwise identified as belonging to, or being associated with, a particular clinical pathway 34 and/or treatment measure provided to a specific patient. In an example embodiment, visual display 38 may provide a graph showing treatment measures over time for a specific patient. A specific treatment measure may be characterized and differentiated visually from other treatment measures by its status, for example, whether it was delivered, not delivered within a time specification of clinical pathway 34, not delivered with contradiction documented, etc. The differentiating features may be presented in color coded format (e.g., each status indicated by a specific color), or other suitable format (e.g., stars, circles, or other geometric pattern, etc.) The graph may also indicate medical data 26, presented according to the time axis of the treatment measures graph, showing, for example an impact of the treatment measures on medical data 26 displayed on the graph. Visual display 38 may be presented in an aesthetically pleasing manner, with visual aids that reveal information upon user selection.

“Visual aids,” as used herein, can include illustrative matter configured to supplement written information and can include colors, icons, and rollovers (e.g., buttons or other images that react when it is selected, for example, when the mouse cursor moves over them). Visual display 38 can provide a succinct chart that can be expanded to reveal relevant information at user 36′s behest. For example, icons on the graph can reveal relevant medical data when the mouse cursor is rolled over the icons, or user 36 clicks on the icons, or otherwise selects the icons.

Turning to the infrastructure of healthcare monitoring system 10, the network topology of network 11 can include any number of servers, routers, gateways, and other nodes inter-connected to form a large and complex network. A node may be any electronic device, client, server, peer, service, application, or other object capable of sending, receiving, or forwarding information over communications channels in a network. Elements of FIG. 1 may be coupled to one another through one or more interfaces employing any suitable connection (wired or wireless), which provides a viable pathway for electronic communications. Additionally, any one or more of these elements may be combined or removed from the architecture based on particular configuration needs.

Healthcare monitoring system 10 may include a configuration capable of TCP/IP communications for the electronic transmission or reception of data packets in a network. Healthcare monitoring system 10 may also operate in conjunction with a User Datagram Protocol/Internet Protocol (UDP/IP) or any other suitable protocol, where appropriate and based on particular needs. In addition, gateways, routers, switches, and any other suitable nodes (physical or virtual) may be used to facilitate electronic communication between various nodes in the network.

Note that the numerical and letter designations assigned to the elements of FIG. 1 do not connote any type of hierarchy; the designations are arbitrary and have been used for purposes of teaching only. Such designations should not be construed in any way to limit their capabilities, functionalities, or applications in the potential environments that may benefit from the features of healthcare monitoring system 10. It should be understood that the healthcare monitoring system 10 shown in FIG. 1 is simplified for ease of illustration.

The example network environment may be configured over a physical infrastructure that may include one or more networks and, further, may be configured in any form including, but not limited to, local area networks (LANs), wireless local area networks (WLANs), virtual local area networks (VLANs), metropolitan area networks (MANs), wide area networks (WANs), virtual private networks (VPNs), Intranet, Extranet, any other appropriate architecture or system, or any combination thereof that facilitates communications in a network.

In some embodiments, a communication link may represent any electronic link supporting a LAN environment such as, for example, cable, Ethernet, wireless technologies (e.g., IEEE 802.11x), ATM, fiber optics, etc. or any suitable combination thereof. In other embodiments, communication links may represent a remote connection through any appropriate medium (e.g., digital subscriber lines (DSL), telephone lines, T1 lines, T3 lines, wireless, satellite, fiber optics, cable, Ethernet, etc. or any combination thereof) and/or through any additional networks such as a wide area networks (e.g., the Internet).

In various embodiments, server 30 may be provisioned with a suitable operating system (or platform, or other appropriate software) that can federate medical data 26 and services data 28 into a federated centralized database, aggregate medical data 26 and services data 28, convert medical data 26 and services data 28 from disparate formats to a uniform format (e.g., XML based format), and store medical data 26 and services data 28 in a suitable data store (e.g., federated centralized database; data store for aggregated data) in cloud 29. The operating system may comprise a plurality of self-contained interconnected modules and service layers for connecting proprietary (and public) systems together and extracting and translating data therefrom to enable them to cooperate in a software ecosystem while allowing flexible connections with both existing and new applications.

According to various embodiments, server 30 includes a software program, or a computing device on which the program runs, that provides a specific kind of service to client software (e.g., client 40) running on the same computing device or other computing devices on network 11. Client 40 may include any electronic device, client, server, peer, service, application, or other object capable of sending, receiving, or forwarding information over a network (e.g., network 11). Examples of client 40 include computers, laptops, smart phones, printers, etc. Client 40 may be provisioned with suitable interfaces (e.g., web browsers) that can render medical data 26 and services data 28, including browser code. In a general sense, client 40 may provide a user interface, such as a graphical user interface (GUI), and perform some or all of the processing on requests it makes from server 30, which maintains the data (e.g., medical data 26 and services data 28) and processes the requests. For ease of illustration, only one server 30 and one client 40 are illustrated in the FIGURE. Virtually any number of servers and clients may be included in healthcare monitoring system 10 within the broad scope of the embodiments.

In some embodiments, patient treatment timeline for measures module 32 may be an application installed on server 30 located in a network (e.g., cloud 29) remote from backend systems 12 and client 40. As used herein, the term “application” can be inclusive of an executable file comprising instructions that can be understood and processed on a computer, and may further include library modules loaded during execution, object files, system files, hardware logic, software logic, or any other executable modules. In other embodiments, patient treatment timeline for measures module 32 may be installed on server 30 located in the same local area network as backend systems 12 and/or client 40. In some embodiments, patient treatment timeline for measures module 32 may be installed on a single computer or server; in other embodiments, patient treatment timeline for measures module 32 may be a distributed application residing on a plurality of devices, including virtual machines. Various hardware and software implementations are possible for patient treatment timeline for measures module 32, all of which are encompassed within the broad scope of the embodiments.

Backend systems 12 can include various computers, measuring instruments, public and proprietary software applications and systems and such other hardware and software components that facilitate operating with myriad medical data sources (e.g., hospitals 14, clinics 16, etc.) and communicating medical data 26 and services data 28 with cloud 29. Backend systems 12 may present various disparate operating systems and platforms to server 30, including EMRs, hospital information systems (HIS), lab and pathology systems (LIS), imaging systems (PACS, RIS), pharmacy systems, scheduling systems, medical devices, etc. In some embodiments, each medical data source may be a separate system, with its own computer network, data format and proprietary applications. In other embodiments, substantially all medical data sources may be part of a single system (e.g., enterprise network, software, etc.) that can interface with each other and with backend systems 12.

Cloud 29 is a collection of hardware and software forming a shared pool of configurable computing resources (e.g., networks, servers, storage, applications, services, etc.) that can be suitably provisioned to provide on-demand self-service, network access, resource pooling, elasticity and measured service, among other features. Cloud 29 may be deployed as a private cloud (e.g., infrastructure operated by a single enterprise/organization), community cloud (e.g., infrastructure shared by several organizations to support a specific community that has shared concerns), public cloud (e.g., infrastructure made available to the general public), or a suitable combination of two or more disparate types of clouds. Cloud 29 may be managed by a cloud service provider, who can provide subscribers (e.g., client 40) with at least access to cloud 29, and authorization to use cloud resources in accordance with predetermined service level agreements.

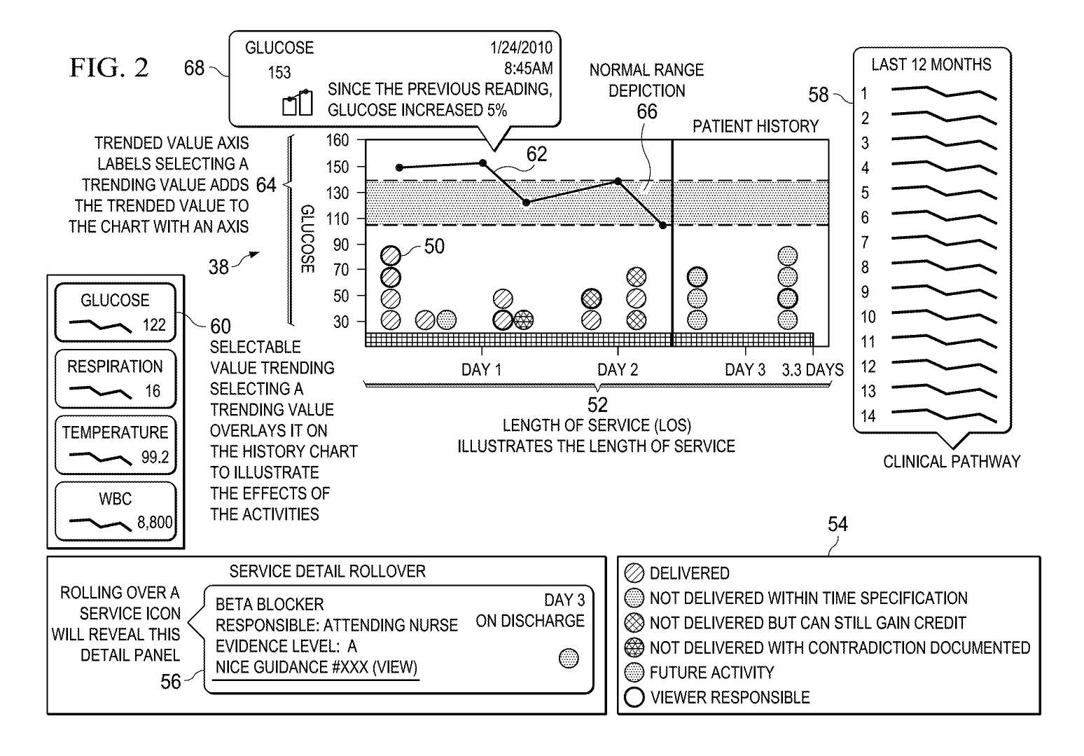

Turning to FIG. 2, FIG. 2 is a simplified diagram illustrating an example visual display 38 according to an embodiment of healthcare monitoring system 10. Visual display 38 may include treatment measures 50 placed along a horizontal axis 52. Horizontal axis 52 may specify any suitable criterion for displaying treatment measures 50. One such example is length of service (LOS) applicable for a specific clinical pathway relevant to visual display 38. The length of service may indicate the time (e.g., days), at which treatment measures 50 is specified to be delivered according to clinical pathway 34. Another example of a parameter for horizontal axis 52 may include the number of patients to which treatment measures 50 was delivered on a particular date. Various other parameters may be used to analyze treatment measures 50 on visual display 38 within the broad scope of the embodiments.

Treatment measures 50 may be interpreted and differentiated from each other according to a legend 54. By way of example, and not as a limitation, legend 54 may specify if a specific treatment measure was delivered or not, whether it was delivered within a time specification provided in clinical pathway 34, whether it was not delivered but such lack of delivery is not relevant to the patient, whether it was not delivered because a contradiction was documented, whether the specific treatment measure refers to a future activity, and whether the viewer (e.g., user 36 viewing visual display 38) is responsible for the specific treatment measure. Legend 54 may provide a quick and qualitative analysis of variance from clinical pathway 34, and user 36 can then perform further actions to analyze each variance in more detail as desired.

In the example visual display 38 illustrated in the FIGURE, treatment measures 50 for days 1 and 2 indicate a past time, whereas day 3 indicates a future time. User 36 may be viewing example visual display 38 sometime during day 2, so that a few treatment measures 50 are illustrated as having been delivered or not delivered; whereas other treatment measures 50 are illustrated as planned for the future. Some of treatment measures 50 may be the responsibility of user 36 viewing example display 38. For example, user 36 may be a physician of the patient whose information is displayed on visual display 38, and the specific treatment measures indicated as “viewer responsible” may pertain to a diagnostic testing to be conducted or evaluated by user 36. In another example, user 36 may be a laboratory technician, and the specific treatment measures indicated as “viewer responsible” may pertain to a laboratory testing to be conducted or evaluated by user 36. In yet another example, user 36 may be a nurse, and the specific treatment measures indicated as “viewer responsible” may pertain to a medicine delivery to be supervised by user 36. Various other such possibilities are included within the broad scope of the embodiments.

In some embodiments, when user 36 rolls a mouse cursor (or other screen tracking device) over a specific treatment measure, a service detail rollover 56 may be displayed concurrently on the screen. For example, service detail rollover 56 may specify the nature (e.g., specific medical service rendered, by whom, on what date, evidence level, etc.)of the specific treatment measure 50, and other associated information, configured according to particular user needs and/or roles. For example, a doctor viewing visual display 38 may see different particulars in service detail rollover 56 than a patient viewing the same visual display 38. A clinical pathway listing 58 may be displayed when user 36 clicks on, rolls the mouse cursor on, or otherwise selects a suitable hyperlink or other selectable option for clinical pathway 34.

Clinical pathway listing 58 may include the treatment measures listed in an ordered manner. In an example embodiment, clinical pathway listing 58 may include the treatment measures listed in chronological order (e.g., treatment measure A on day 1 in the morning; treatment measure B on day 1 at noon; etc.). In another embodiment, clinical pathway listing 58 may include the treatment measures listed according to the type of treatment measure (e.g., laboratory analysis; diagnostic testing by physician; prescription; etc.). In yet another embodiment, clinical pathway listing 58 may include the treatment measures listed according to the LOS (e.g., treatment measures A, B, C on day 1, D,E on day 2, etc. if the LOS is according to days). User 36 may view listing 58 and compare manually with treatment measures 50 as displayed on visual display 38.

Visual display 38 may also include a selectable value trending 60, comprising a chart indicating a change of a selected parameter over horizontal axis 52. In example visual display 38, one of glucose level, respiration, temperature and white blood count (WBC) can be selected and overlaid (e.g., superimposed, placed on top, displayed concurrently with another graph, such as treatment measures 50) on the chart. Any suitable parameter may be selected for selectable value trending 60 within the broad scope of the embodiments. A trended value axis 64 may also be displayed to indicate labels applicable to the overlay parameter selected for selectable value trending 60. A normal depiction range 66 may indicate a normal (e.g., healthy, expected) level for the overlay parameter. Each reading on line 62 may correspond to a timeline relevant to horizontal axis 52, so that the correspondence of the overlay parameter with treatment measures 50 may be qualitatively analyzed. Clicking or otherwise selecting (e.g., hovering mouse cursor proximate to, highlighting, pointing, etc.) a specific reading on line 62 may reveal a value detail rollover 68 indicating the value of the reading, date and time of the reading (or date and time the reading was entered in healthcare monitoring system 10), a trend, indicating relative change from a previous reading, and other information that may be relevant to user 36 viewing the data, and/or specific selectable value trending 60.

In some embodiments, selectable value trending 60 may be displayed as a spark line chart (e.g., small line chart, typically drawn without axes or coordinates and presenting the general shape of the variation (typically over time) in some measurement, such as selectable value trending 60). Whereas a typical chart is designed to show as much data as possible, and is set off from the flow of text, spark lines are intended to be succinct, memorable, and located where they are discussed (e.g., alongside chart displaying treatment measures 50). In other embodiments, selectable value trending 60 may be displayed as a scatter plot, a bar chart, or in any other suitable format, based on its type and user needs. For example, in visual display 38 illustrated in the FIGURE, readings corresponding to selectable value trending 60 are displayed as a line chart, with corresponding axes.

It may be noted that visual display 38 illustrated in the FIGURE is merely for example purposes. Visual display 38 may include other options and information based on the type of items displayed and the audience, for example, a role (e.g., physician, patient, hospital administrator, payor, etc.) of user 36. In an example embodiment, the options displayed may be different for a physician and a patient. Whereas the physician may be able to see medical details, terminologies, chemical compositions of medications, medical notes by other physicians and medical professionals, the patient may be able to see medications according to their common names, without medical terminologies or other jargon that could confuse the patient. In other embodiments, the options displayed may be the same for any user, irrespective of the role of user 36.

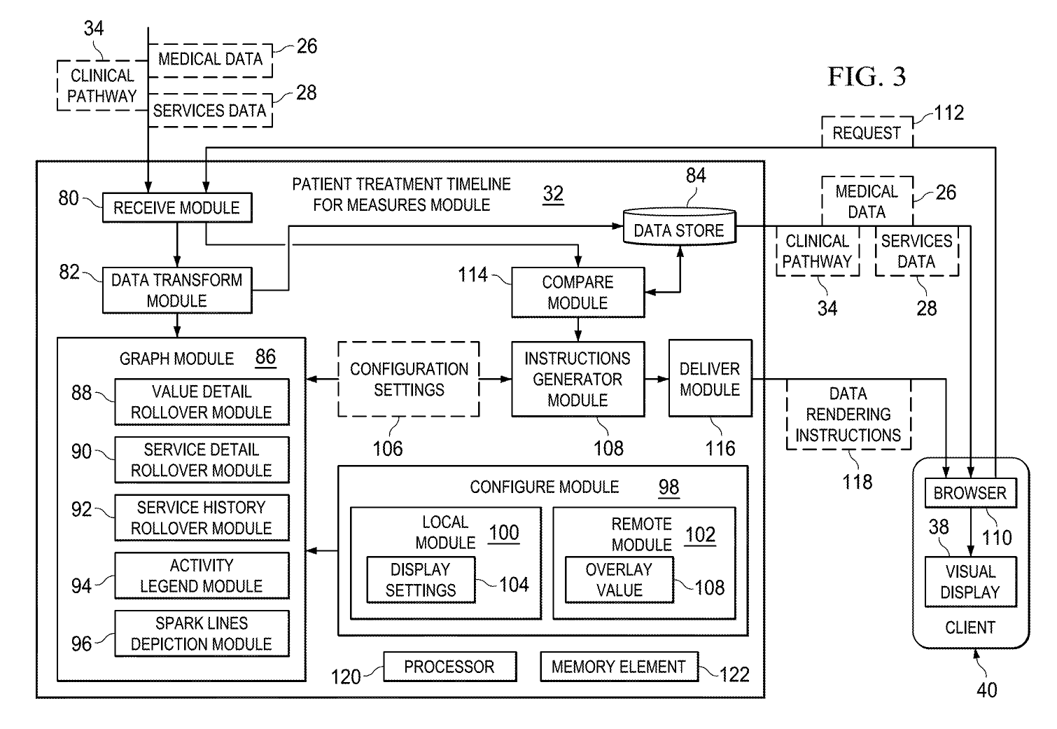

Turning to FIG. 3, FIG. 3 is a simplified block diagram illustrating example details of an embodiment of healthcare monitoring system 10. Patient treatment timeline for measures module 32 may include a receive module 80 that is configured to receive data comprising clinical pathway 34, medical data 26 and services data 28. Receive module 80 may be configured with appropriate network interfaces to communicate with backend systems 12 and receive clinical pathway 34, medical data 26, and services data 28.

A data transform module 82 may transform clinical pathway 34, medical data 26 and services data 28 from their respective formats (e.g., arrangement of data for storage, display, communication, printing, etc. such as hypertext markup language (HTML), text, and extensible markup language (XML), Microsoft Word (*.doc), Microsoft Excel (*.xls)), etc.) to a uniform format (e.g., data arrangements that can be rendered on a common interface simultaneously, such as HTML format that can permit a web browser to render text and images simultaneously) and store the uniform format data in a data store 84. In some embodiments, data transform module 82 may implement object-relational mapping (ORM) (e.g., automated and transparent persistence of objects to tables in a relational database by using appropriate metadata, which describes mapping between the objects and the database) to convert data between incompatible type systems. In other embodiments, data transform module 82 may use native procedural language (associated with databases) to perform the conversion from disparate formats to the uniform format.

In some embodiments, data transform module 82 may implement Extract-Transform-Load (ETL) processes to extract data from the plurality of data sources, transform it appropriately, and load it into data store 84. Extracting may involved consolidating data from a variety of data sources having mutually incompatible systems, formats, organization, structure, or procedures. Example systems, formats, organization, structure, or procedures may include relational databases, flat files, Information Management System (IMS), Virtual Storage Access Method (VSAM), Indexed Sequential Access Method (ISAM), web spidering and screen-scraping. Transforming may include applying a series of rules or functions (e.g., parsing, sorting, translating, selecting, concatenating, joining, aggregating, transposing, pivoting, splitting columns and/or rows, validating, etc.) to the extracted data to derive the uniform format data. Loading may include saving the uniform format data into data store 84, and can involve overwriting duplicative data, adding data in chronological order (e.g., with timestamps), etc. that take into account constraints (e.g., uniqueness, referential integrity, etc.) of the database schema of data store 84.

In many embodiments, data store 84 may comprise a federated centralized database that stores metadata of clinical pathway 34, medical data 26 and services data 28. In other embodiments, data store 84 may comprise a database that aggregates information from clinical pathway 34, medical data 26 and services data 28 appropriately and based on particular needs.

A graph module 86 may facilitate preparing visual display 38. Graph module 86 may include a value detail rollover module 88 that can enable value detail rollover 68. A service detail rollover module 90 can enable service detail rollover 56. A service history rollover module 92 can enable displaying service history (e.g., treatment measures 50 across LOS). An activity legend module 94 can enable displaying legend 54. A spark lines depiction module 96 may enable displaying selectable value trending 60 in a suitable sparkline, line chart, or other format as desired.

A configure module 98 may facilitate configuring visual display 38 by graph module 86 appropriately. Configure module 98 may include a local module 100 and a remote module 102. Local module 100 may permit configuration settings (e.g., default values) whereas remote module 102 may permit configuration changes by user 36 at client 40. Local module 100 may enable configuring display settings 104, and remote module 102 may enable configuring overlay values 108, including for selectable value trending 60. Configuration settings 106 prepared by graph module 86 may be provided to an instructions generator module 108.

During operation, a browser 110 of client 40 may send a request 112 to patient treatment timeline for measures module 32 requesting visual display 38. Receive module 80 may receive request 112 and inform a compare module 114 of request 112. Compare module 114 may compare services data 28 and clinical pathway 34 to determine treatment measures 50, including the status of treatment measures 50 (e.g., whether treatment measures 50 have been delivered, not delivered, etc.). In some embodiments, compare module 114 may access medical data 26, services data 28 and clinical pathway 34 in data store 84 to perform the comparison. Compare module 114 may deliver comparison information (e.g., which treatment measures have been delivered, which ones have not been delivered, etc.) to instructions generator module 108.

Instructions generator module 108 may generate data rendering instructions 118 according to the configuration settings 104 and the comparison information provided by compare module 114. Data rendering instructions 118 may include configuration options by remote module 102 that can permit user 36 to change the displayed values and format. Data rendering instructions 118 may include location of medical data 26, services data 28 and clinical pathway 34 to be displayed, among other features. In an example embodiment, data rendering instructions 118 may be an XML file, with definitions for selected items to be displayed. A delivery module 116 may deliver data rendering instructions 118 to client 40. Browser 110 at client 40 may receive data rendering instructions 118. Accordingly, browser 110 may pull medical data 26, services data 28 and clinical pathway 34 stored in data store 84 and display it on visual display 38 according to data rendering instructions 118.

A processor 120 and a memory element 122 may facilitate the operations described herein. In various embodiments, processor 120 and memory element 122 may be part of server 30; in other embodiments, processor 120 and memory element 122 may be part of patient treatment timeline for measures module 32, which may be embedded in server 30.

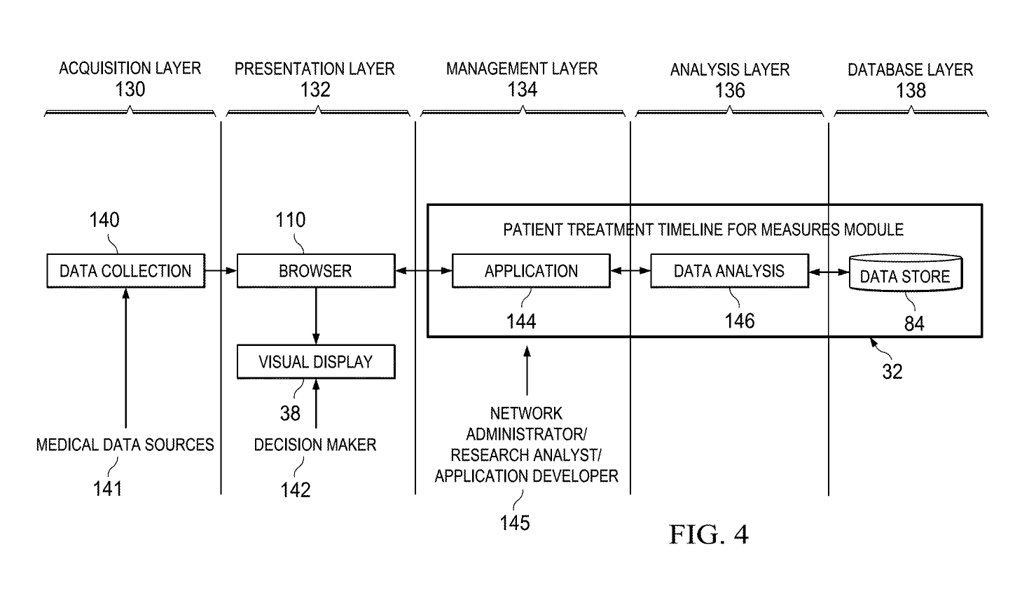

Turning to FIG. 4, FIG. 4 is a simplified diagram illustrating example details of an embodiment of healthcare monitoring system 10. In an example embodiment, healthcare monitoring system 10 may be implemented in several layers, including an acquisition layer 130, a presentation layer 132, a management layer 134, an analysis layer 136 and a database layer 138. Data collection 140 in acquisition layer 130 may involve collecting data, including medical data 26, services data 28, and clinical pathway 34, from one or more medical data sources 141. Medical data sources 141 may include hospitals, physicians, laboratories, healthcare facilities, patients, and other caregivers and associated entities that can provide data for data collection 140. Browser 110 (e.g., in client 40) in presentation layer 132 may enable visual display 38 to a decision marker 142 (e.g., physician, patient, etc.). Browser 110 may enable displaying data collected by data collection 140, enabled by an application 144 in management layer 134. Application 144 may be accessed, controlled and/or configured by a network administrator/research analyst/application developer 145. Application 144 may interact with a data analysis 146 in analysis layer 136, which may use data stored in data store 84 in database layer 138. In the example embodiment illustration in the FIGURE, patient treatment timeline for measures module 32 may comprise application 144, data analysis 146 and data store 84 in management layer 134, analysis layer 136, and database layer 138, respectively.

In the example embodiment, database layer 138 may facilitate building a clinical data warehouse comprising medical data 26, services data 28 and clinical pathway 34. Data analysis 146 may comprise analysis using statistical tools, algorithms, data mining and other functions to enable the operations described herein. In some embodiments, analysis layer 136 may include database and application servers with remote computation or offline data mining capabilities. Application 144 in management layer 134 may control and manage the flow of data from data collection 140 to data store 84, and back to visual display 38. A management interface may be configured with application 144 to data access functions for users 36, for example, to enable visual display 38.

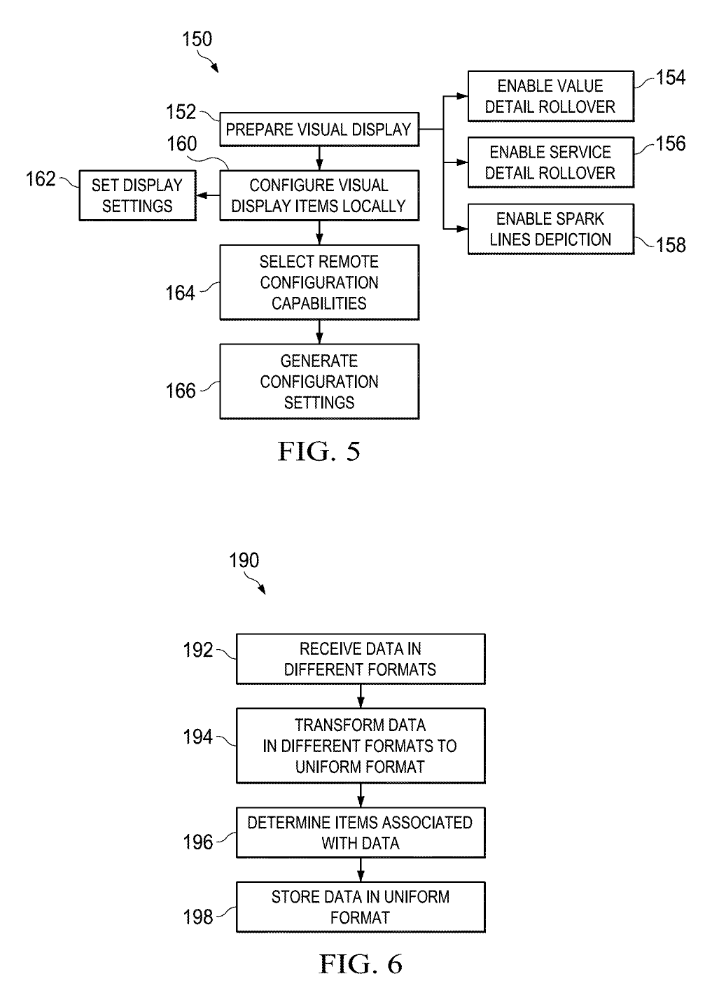

Turning to FIG. 5, FIG. 5 is a simplified flow diagram illustrating example operations that may be associated with generating visual display 38 according to an embodiment of healthcare monitoring system 10. Operations 150 may include 152, at which visual display 38 may be prepared according to various operations, including 154, at which value detail rollover 68 may be enabled; 156, at which service detail rollover 56 may be enabled; and 158, at which spark lines depiction may be enabled. At 160, visual display items may be locally configured (e.g., by local module 100). Local configuration may include setting default display settings. At 164, remote configuration capabilities may be selected. At 166, configuration settings 106 may be generated. Configuration settings 106 may include substantially all configuration options, values, selections, choices, etc. that may be used to render visual display 38.

Turning to FIG. 6, FIG. 6 is a simplified flow diagram illustrating example operations that may be associated with an embodiment of healthcare monitoring system 10. Operations 190 may include 192, at which data, including medical data 26, services data 28 and clinical pathway 34 may be received in different formats. At 194, the data (e.g., medical data 26, services data 28 and clinical pathway 34) in different formats may be converted to a uniform format. At 196, items associated with the data (e.g., medical data 26, services data 28 and clinical pathway 34) may be determined. For example, medical data 26(1) may be determined to be a weight reading of patient X taken at Southside medical clinic on 1/24; medical data 26(2) may be determined to be a chest CT scan of the same patient; and so on. Services data 28(1) may be identified as a laboratory testing performed at QLabs on 1/24; services data 26(2) may be identifies as a diagnosis service by a physician at H Hospital on 2/28; and so on. At 198, the data in uniform format may be stored in data store 84.

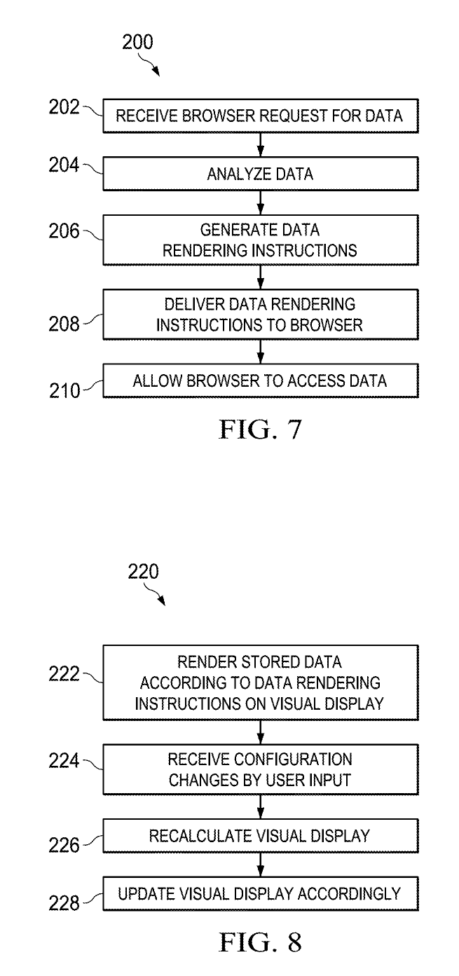

Turning to FIG. 7, FIG. 7 is a simplified flow diagram illustrating example operations that may be associated with embodiments of healthcare monitoring system 10. Operations 200 include 202, at which request 112 for data (e.g., medical data 26, services data 28 and clinical pathway 34) may be received from browser 110. At 204, data may be analyzed to determine status of treatment measures 50. For example, information pertaining to treatment measures 50 may be derived from services data 28 and medical data 26. The derived information may be compared with clinical pathway 34 to identify the treatment measures that have been delivered, not delivered, etc. as appropriate. At 206, data rendering instructions 118 may be generated. At 208, data rendering instructions 118 may be delivered to browser 110. At 210, browser 110 may be allowed to access the data (e.g., medical data 26, services data 28 and clinical pathway 34) stored in data store 84 in uniform format.

Turning to FIG. 8, FIG. 8 is a simplified flow diagram illustrating example operations associated with browser 110 according to an embodiment of healthcare monitoring system 10. Operations 220 include 222, at which browser 110 may render stored data (e.g., medical data 26, services data 28 and clinical pathway 34) according to data rendering instructions 118 on visual display 38. At 224, configurations of visual display 38 may be changed remotely by user input. For example, the user input may specify that selectable value trending 60 displays a different overlay parameter. At 226, browser 110 may recalculate visual display 38. Such recalculations may be performed at client 40 in some embodiments; in other embodiments, the instructions to recalculate may be sent by client 40 to patient treatment timeline for measures module 32 at server 30. Patient treatment timeline for measures module 32 may recalculate the trend and deliver the result to browser 110. At 228, browser 110 may update visual display 38 accordingly.

Note that in this Specification, references to various features (e.g., elements, structures, modules, components, steps, operations, characteristics, etc.) included in “one embodiment”, “example embodiment”, “an embodiment”, “another embodiment”, “some embodiments”, “various embodiments”, “other embodiments”, “alternative embodiment”, and the like are intended to mean that any such features are included in one or more embodiments of the present disclosure, but may or may not necessarily be combined in the same embodiments.

In example implementations, at least some portions of the activities outlined herein may be implemented in software in, for example, patient treatment timeline for measures module 32. In some embodiments, one or more of these features may be implemented in hardware, provided external to these elements, or consolidated in any appropriate manner to achieve the intended functionality. The various network elements may include software (or reciprocating software) that can coordinate in order to achieve the operations as outlined herein. In still other embodiments, these elements may include any suitable algorithms, hardware, software, components, modules, interfaces, or objects that facilitate the operations thereof.

Furthermore, patient treatment timeline for measures module 32 described and shown herein (and/or its associated structures) may also include suitable interfaces for receiving, transmitting, and/or otherwise communicating data or information in a network environment. Additionally, some of the processors and memory elements associated with the various nodes may be removed, or otherwise consolidated such that a single processor and a single memory element are responsible for certain activities. In a general sense, the arrangements depicted in the FIGURES may be more logical in their representations, whereas a physical architecture may include various permutations, combinations, and/or hybrids of these elements. It is imperative to note that countless possible design configurations can be used to achieve the operational objectives outlined here. Accordingly, the associated infrastructure has a myriad of substitute arrangements, design choices, device possibilities, hardware configurations, software implementations, equipment options, etc.

In some of example embodiments, one or more memory elements (e.g., memory element 122, data store 84) can store data used for the operations described herein. This includes the memory element being able to store instructions (e.g., software, logic, code, etc.) in non-transitory media such that the instructions are executed to carry out the activities described in this Specification.

A processor can execute any type of instructions associated with the data to achieve the operations detailed herein in this Specification. In one example, processors (e.g., processor 120) could transform an element or an article (e.g., data) from one state or thing to another state or thing. In another example, the activities outlined herein may be implemented with fixed logic or programmable logic (e.g., software/computer instructions executed by a processor) and the elements identified herein could be some type of a programmable processor, programmable digital logic (e.g., a field programmable gate array (FPGA), an erasable programmable read only memory (EPROM), an electrically erasable programmable read only memory (EEPROM)), an ASIC that includes digital logic, software, code, electronic instructions, flash memory, optical disks, CD-ROMs, DVD ROMs, magnetic or optical cards, other types of machine-readable mediums suitable for storing electronic instructions, or any suitable combination thereof.

In operation, components in healthcare monitoring system 10 can include one or more memory elements (e.g., memory element 122, data store 84) for storing information to be used in achieving operations as outlined herein. These devices may further keep information in any suitable type of non-transitory storage medium (e.g., random access memory (RAM), read only memory (ROM), field programmable gate array (FPGA), erasable programmable read only memory (EPROM), electrically erasable programmable ROM (EEPROM), etc.), software, hardware, or in any other suitable component, device, element, or object where appropriate and based on particular needs.

The information being tracked, sent, received, or stored in healthcare monitoring system 10 could be provided in any database, register, table, cache, queue, control list, or storage structure, based on particular needs and implementations, all of which could be referenced in any suitable timeframe. Any of the memory items discussed herein should be construed as being encompassed within the broad term ‘memory element.’ Similarly, any of the potential processing elements, modules, and machines described in this Specification should be construed as being encompassed within the broad term ‘processor.’

It is also important to note that the operations and steps described with reference to the preceding FIGURES illustrate only some of the possible scenarios that may be executed by, or within, the system. Some of these operations may be deleted or removed where appropriate, or these steps may be modified or changed considerably without departing from the scope of the discussed concepts. In addition, the timing of these operations may be altered considerably and still achieve the results taught in this disclosure. The preceding operational flows have been offered for purposes of example and discussion. Substantial flexibility is provided by the system in that any suitable arrangements, chronologies, configurations, and timing mechanisms may be provided without departing from the teachings of the discussed concepts.

Although the present disclosure has been described in detail with reference to particular arrangements and configurations, these example configurations and arrangements may be changed significantly without departing from the scope of the present disclosure. For example, although the present disclosure has been described with reference to particular communication exchanges involving certain network access and protocols, healthcare monitoring system 10 may be applicable to other exchanges or routing protocols. Moreover, although healthcare monitoring system 10 has been illustrated with reference to particular elements and operations that facilitate the communication process, these elements, and operations may be replaced by any suitable architecture or process that achieves the intended functionality of healthcare monitoring system 10.

Numerous other changes, substitutions, variations, alterations, and modifications may be ascertained to one skilled in the art and it is intended that the present disclosure encompass all such changes, substitutions, variations, alterations, and modifications as falling within the scope of the appended claims. In order to assist the United States Patent and Trademark Office (USPTO) and, additionally, any readers of any patent issued on this application in interpreting the claims appended hereto, Applicant wishes to note that the Applicant: (a) does not intend any of the appended claims to invoke paragraph six (6) of 35 U.S.C. section 112 as it exists on the date of the filing hereof unless the words “means for” or “step for” are specifically used in the particular claims; and (b) does not intend, by any statement in the specification, to limit this disclosure in any way that is not otherwise reflected in the appended claims.

What is claimed is:

1. A method, comprising:
receiving a request from a client for data in a network environment, wherein the data includes services data and a clinical pathway;
generating data rendering instructions for rendering the data as a visual display at the client, wherein the data rendering instructions include options to configure the visual display, wherein the visual display comprises a graphical representation of analysis of the services data in view of the clinical pathway, and visual aids that reveal information upon user selection;
delivering the data rendering instructions to the client; and
facilitating access to the data by the client.

2. The method of claim 1, wherein the data includes medical data, and wherein the visual display includes another graphical representation of the medical data, wherein the another graphical representation is overlaid on the graphical representation of analysis of the services data in view of the clinical pathway.

3. The method of claim 2, wherein the another graphical representation is a spark line depiction.

4. The method of claim 2, wherein the medical data includes an overlay parameter selectable by a user viewing the visual display.

5. The method of claim 2, wherein at least one data point of the another graphical representation is selectable to reveal details about the data point.

6. The method of claim 1, wherein the visual display is configurable to display the services data according to a length of service specified in the clinical pathway.

7. The method of claim 1, wherein the graphical representation comprises one or more data points corresponding to treatment measures, wherein at least one data point is selectable to reveal details about the data point.

8. The method of claim 7, wherein the graphical representation includes status of the treatment measures, wherein the status is one of a group comprising: “delivered,” “not delivered within time specification,” “not delivered but can still gain credit,” “not delivered with contradiction documented,” “future activity,” and “viewer responsible.”

9. The method of claim 8, wherein the status is determined from comparison of the treatment measures with the clinical pathway.

10. The method of claim 1, wherein the visual display is rendered on a browser at the client, and wherein the request is sent by the browser to a server configured with an operating system comprising a plurality of self-contained interconnected modules and service layers for connecting proprietary and public systems together and extracting and translating data therefrom to enable them to cooperate in a software ecosystem while allowing flexible connections with both existing and new applications.

11. Logic encoded in non-transitory media that includes instructions for execution and when executed by a processor, is operable to perform operations comprising:
receiving a request from a client for data in a network environment, wherein the data includes services data and a clinical pathway;
generating data rendering instructions for rendering the data as a visual display at the client, wherein the data rendering instructions include options to configure the visual display, wherein the visual display comprises a graphical representation of analysis of the services data in view of the clinical pathway, and visual aids that reveal information upon user selection;
delivering the data rendering instructions to the client; and
facilitating access to the data by the client.

12. The logic of claim 11, wherein the data includes medical data, and wherein the visual display includes another graphical representation of the medical data, wherein the another graphical representation is overlaid on the graphical representation of analysis of the services data in view of the clinical pathway.

13. The logic of claim 11, wherein the graphical representation comprises one or more data points corresponding to treatment measures, wherein at least one data point is selectable to reveal details about the data point.

14. The logic of claim 13, wherein the graphical representation includes status of the treatment measures, wherein the status is one of a group comprising: “delivered,” “not delivered within time specification,” “not delivered but can still gain credit,” “not delivered with contradiction documented,” “future activity,” and “viewer responsible.”

15. The method of claim 14, wherein the status is determined from comparison of the treatment measures with the clinical pathway.

16. An apparatus, comprising:
a receive module;
an instructions generator module;
a deliver module;
a memory element to store data; and
a processor to execute instructions associated with the data, wherein the receive module, the instructions generator module, the deliver module, the processor and the memory element cooperate such that the apparatus is configured for:
receiving a request from a client for data in a network environment, wherein the data includes services data and a clinical pathway;
generating data rendering instructions for rendering the data as a visual display at the client, wherein the data rendering instructions include options to configure the visual display, wherein the visual display comprises a graphical representation of analysis of the services data in view of the clinical pathway, and visual aids that reveal information upon user selection;
delivering the data rendering instructions to the client; and
facilitating access to the data by the client.

17. The apparatus of claim 16, wherein the data includes medical data, and wherein the visual display includes another graphical representation of the medical data, wherein the another graphical representation is overlaid on the graphical representation of analysis of the services data in view of the clinical pathway.

18. The apparatus of claim 16, wherein the graphical representation comprises one or more data points corresponding to treatment measures, wherein at least one data point is selectable to reveal details about the data point.

19. The apparatus of claim 18, further comprising a compare module, wherein the graphical representation includes status of the treatment measures, wherein the status is one of a group comprising: “delivered,” “not delivered within time specification,” “not delivered but can still gain credit,” “not delivered with contradiction documented,” “future activity,” and “viewer responsible.”

20. The apparatus of claim 19, wherein the status is determined from comparison of the treatment measures with the clinical pathway.
